(19) United States
(12) Patent Application Publication
(10) Pub. No.: US 2026/0291671 A1
(43) Pub. Date: Sep. 24, 2026

(54) System and Method for Determining Switching Period Location for Uplink Transmit Switching

(71) Applicant: Apple Inc., Cupertino, CA (US)

(72) Inventors: Ankit Bhamri, Haar (DE); Wei Zeng, Saratoga, CA (US); Haitong Sun, Saratoga, CA (US); Dawei Zhang, Saratoga, CA (US); Qiming Li, Beijing (CN); Hong He, San Jose, CA (US)

(21) Appl. No.: 19/472,558

(22) PCT Filed: Apr. 4, 2023
(86) PCT No.: PCT/CN2023/086178

§ 371 Date: Oct. 3, 2025

(51) Int. Cl. H04L 5/00

(52) U.S. Cl. CPC H04L 5/0044; H04L 5/0098

(57) ABSTRACT

The location of the switching period for UL TX switching of a user equipment device, UE, may be configured and identified for cases when a scheduling gap between current frequency bands used by the UE before the UL TX switching and target frequency bands used by the UE after the UL TX switching is long enough to contain the switching gap used by the UE for the UL TX switching. The UE may identify the switching gap location according to reporting of downlink communication interruption on at least one of the frequency bands involved in the UL TX switching, reporting of the switching gap, and reporting of a capability of the device to use a configured switching gap location specified in the standards. The location of the switching gap may also depend on the priority level of the frequency bands involved in the UL TX switching and/or one or more related parameters, and may be left up to implementation of the UE under certain conditions.

### FIELD OF THE INVENTION

The present application relates to wireless communications, including discovery of user plane functions with network address translation capability during wireless communications, e.g., during 5G NR communications.

### DESCRIPTION OF THE RELATED ART

Wireless communication systems are rapidly growing in usage. In recent years, wireless devices such as smart phones and tablet computers have become increasingly sophisticated. In addition to supporting telephone calls, many mobile devices (i.e., user equipment devices or UEs) now provide access to the internet, email, text messaging, and navigation using the global positioning system (GPS), and are capable of operating sophisticated applications that utilize these functionalities. Additionally, there exist numerous different wireless communication technologies and standards. Some examples of wireless communication standards include LTE, LTE Advanced (LTE-A), HSPA, 3GPP2 CDMA2000 (e.g., 1xRTT, 1xEV-DO, HRPD, eHRPD), IEEE 802.11 (WLAN or Wi-Fi), IEEE 802.16 (WiMAX), IEEE 802.15 (Ultra-Wideband, UWB), BLUETOOTH™, etc. A current telecommunications standard moving beyond previous standards is called 5th generation mobile networks or 5th generation wireless systems, referred to as 3GPP NR (otherwise known as 5G-NR or NR-5G for 5G New Radio, also simply referred to as NR). NR proposes a higher capacity for a higher density of mobile broadband users, also supporting device-to-device, ultra-reliable, and massive machine communications, as well as lower latency and lower battery consumption, than LTE standards.

One aspect of wireless communications, e.g., NR cellular wireless communications, is switching between uplink communications and downlink communications, or between transmitting signals and receiving signals, respectively, at a wireless communication device/user equipment device (UE.)

### SUMMARY OF THE INVENTION

Embodiments are presented herein of, inter alia, of methods and procedures for determining the switching period location for uplink (UL) transmit (TX) switching during wireless communications, for example during 3GPP New Radio (NR) communications. Embodiments are further presented herein for wireless communication systems containing at least wireless communication devices or user equipment devices (UEs) and/or base stations communicating with each other within the wireless communication systems.

As disclosed herein, the location of the switching period for UL TX switching of a UE may be configured and identified for cases when a scheduling gap between one or more current frequency bands used by the UE before the UL TX switching and one or more target frequency bands used by the UE after the UL TX switching is long enough to contain the switching gap used by the UE for the UL TX switching. The UE may identify the switching gap location according to reporting, by the UE to a serving base station, of one or more of: a downlink communication interruption on at least one of the frequency bands involved in the UL TX switching, the switching gap, and a capability of the device to support use of a configured switching gap location specified in the standards. The location of the switching gap may also depend on the priority level of the frequency bands involved in the UL TX switching and/or one or more related parameters, and may be left up to implementation of the UE under certain conditions.

In some embodiments, a device may identify the location of a switching gap for the device switching UL transmission from at least a first frequency band to at least a second frequency band, when the duration of a scheduling gap between the first frequency band and the second frequency band is longer than the duration of the switching gap. The device may identify the location of the switching gap according to at least one of: reporting of downlink communication interruption on at least one of the first frequency band and the second frequency band, reporting of the switching gap, and/or reporting of a capability of the device to support use of a configured switching gap location. The device may then perform the switching during the switching gap according to the identified location of the switching gap. The UE may identify the location of the switching gap based on the reporting outlined above when the duration of the scheduling gap is greater than the duration of the switching gap.

In some embodiments, the identified location of the switching gap may end at the end of the scheduling gap. Furthermore, the identified location of the switching gap may end at the end of the scheduling gap in response to a switching gap location parameter received by the device identifying the second frequency band, and/or the first frequency band having a higher priority than the second frequency band.

In some embodiments, the identified location of the switching gap may start at the beginning of the scheduling gap. Furthermore, the identified location of the switching gap may start at the beginning of the scheduling gap in response to the switching gap location parameter received by the device identifying the first frequency band, and/or the second frequency band having a higher priority than the first frequency band.

In some embodiments, the identified location of the switching gap may start at a midpoint of the scheduling gap or it may end at the midpoint of the scheduling gap.

In some embodiments, the identified location of the switching gap may be the configured switching gap location when the duration of the scheduling gap is longer than the duration of the switching gap, and the device reports the switching gap and/or a downlink communication interruption on the first frequency band and/or the second frequency band. The identified location of the switching gap may also be the configured switching gap location when the device reports a downlink communication interruption on all bands within a band combination of a switching instance, a downlink communication interruption on all bands involved in a given switching instance, and/or a downlink communication interruption on at least one band that is involved in a given switching instance.

Note that the techniques described herein may be implemented in and/or used with a number of different types of devices, including but not limited to, base stations, access points, cellular phones, portable media players, tablet computers, wearable devices, and various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

FIG. 1 illustrates an exemplary (and simplified) wireless communication system, according to some embodiments;

FIG. 2 illustrates an exemplary base station in communication with an exemplary wireless user equipment (UE) device, according to some embodiments;

FIG. 3 illustrates an exemplary block diagram of a UE, according to some embodiments;

FIG. 4 illustrates an exemplary block diagram of a base station, according to some embodiments;

FIG. 5 shows an exemplary simplified block diagram illustrative of cellular communication circuitry, according to some embodiments;

FIG. 6 shows an exemplary timing diagram illustrating the switching period location(s) with one of two frequency bands set “true” for switching period location with no scheduling gap between the two frequency bands for uplink (UL) transmit (TX) switching;

FIG. 7 shows an exemplary timing diagram illustrating the scheduling gap and switching gap for UL TX switching, with the scheduling gap long enough to contain the switching gap duration between the initial and final band for UL TX switching;

FIG. 8 shows an exemplary timing diagram illustrating the switching gap for UL TX switching configured at the end of the scheduling gap, according to some embodiments;

FIG. 9 shows an exemplary timing diagram illustrating the switching gap for UL TX switching configured at the start of the scheduling gap, according to some embodiments;

FIG. 10 shows an exemplary timing diagram illustrating the switching gap for UL TX switching configured to end at the center/midpoint of the scheduling gap, according to some embodiments

FIG. 11 shows an exemplary timing diagram illustrating the switching gap for UL TX switching configured to start at the center/midpoint of the scheduling gap, according to some embodiments;

FIG. 12 shows an exemplary timing diagram illustrating the switching gap for UL TX switching configured based on the uplinkTXSwitchingPeriodLocation parameter, according to some embodiments; and

FIG. 13 shows an exemplary flow diagram of a method for performing UL TX switching, according to some embodiments.

While features described herein are susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION OF THE EMBODIMENTS

### Acronyms

Various acronyms are used throughout the present application. Definitions of the most prominently used acronyms that may appear throughout the present application are provided below:
5GMM: 5G Mobility Management
AC: Application Client
AF: Application Function
AMF: Access and Mobility Management Function
AMR: Adaptive Multi-Rate
AP: Access Point
APN: Access Point Name
APR: Applications Processor
BS: Base Station
BSF: Binding Support Function
BSSID: Basic Service Set Identifier
CA: Carrier Aggregation
CE: Control Element
CBG: Code Block Group
CBRS: Citizens Broadband Radio Service
CBSD: Citizens Broadband Radio Service Device
CBW: Channel Bandwidth
CCA: Clear Channel Assessment
CMR: Change Mode Request
CORESET: Control Resource Set
CS: Circuit Switched
CSI: Channel State Information
DC: Dual Connectivity
DCI: Downlink Control Information
DL: Downlink (from BS to UE)
DMRS: Demodulation Reference Signal
DN: Data Network
DNN: Data Network Name
DSDS: Dual SIM Dual Standby
DYN: Dynamic
E-UTRA: Evolved UTRA
EDCF: Enhanced Distributed Coordination Function
EN-DC: E-UTRA NR Dual Connectivity
ETSI: European Telecommunications Standards Institute
FDD: Frequency Division Duplexing
FT: Frame Type
GAA: General Authorized Access
GPSI: Generic Public Subscription Identifier
GPRS: General Packet Radio Service
GSM: Global System for Mobile Communication
GTP: GPRS Tunneling Protocol
HPLMN: Home Public Land Mobile Network
IC: In Coverage
ICBM: Inter-Cell Beam Management
IMS: Internet Protocol Multimedia Subsystem
IOT: Internet of Things
IP: Internet Protocol
ITS: Intelligent Transportation Systems
LAN: Local Area Network
LBT: Listen Before Talk
LCID: Logical Channel ID
LCS: Location Services
LMF: Location Management Function
LPP: LTE Positioning Protocol
LQM: Link Quality Metric
LTE: Long Term Evolution
MAC: Media Access Control
MCC: Mobile Country Code
MCS: Modulation and Coding Scheme
MNO: Mobile Network Operator
MO-LR: Mobile Originated Location Request
MT-LR: Mobile-Terminated Location Request
NAT: Network Address Translation
NAS: Non-Access Stratum
NDI: New Data Indicator
NEF: Network Exposure Function
NF: Network Function
NG-RAN: Next Generation Radio Access Network
NID: Network Identifier
NMF: Network Identifier Management Function
NPN: Non-Public (cellular) Network
NR: New Radio
NRF: Network Repository Function
NSI: Network Slice Instance
NSSAI: Network Slice Selection Assistance Information
OOC: Out Of Coverage
PAL: Priority Access Licensee
PBCH: Physical Broadcast Channel
PDCCH: Physical Downlink Control Channel
PDCP: Packet Data Convergence Protocol
PDN: Packet Data Network
PDSCH: Physical Downlink Shared Channel
PDU: Protocol Data Unit
PGW: PDN Gateway
PLMN: Public Land Mobile Network
ProSe: Proximity Services
PRS: Positioning Reference Signal
PSCCH: Physical Sidelink Control Channel
PSFCH: Physical Sidelink Feedback Channel
PSSCH: Physical Sidelink Shared Channel
PSD: Power Spectral Density
PSS: Primary Synchronization Signal
PT: Payload Type
PTRS: Phase Tracking Reference Signal
PUCCH: Physical Uplink Control Channel
PUSCH: Physical Uplink Shared Channel
QBSS: Quality of Service Enhanced Basic Service Set
QI: Quality Indicator
RA: Registration Accept
RAN: Radio Access Network
RAT: Radio Access Technology
RF: Radio Frequency
RLM: Radio Link Monitoring
RNTI: Radio Network Temporary Identifier
ROHC: Robust Header Compression
RR: Registration Request
RRC: Radio Resource Control
RRM: Radio Resource Management
RS: Reference Signal
RSRP: Reference Signal Receive Power
RTP: Real-time Transport Protocol
RV: Redundancy Version
RX: Reception/Receive
SAS: Spectrum Allocation Server
SCS: Subcarrier Spacing
SD: Slice Descriptor
SI: System Information
SIB: System Information Block
SID: System Identification Number
SIM: Subscriber Identity Module
SINR: Signal-To-Interference-Plus-Noise Ratio
SGW: Serving Gateway
SMF: Session Management Function
SNPN: Standalone Non-Public Network
SRS: Sounding Reference Signal
SSB: Synchronization Signal Block
SSS: Secondary Synchronization Signal
SUPI: Subscription Permanent Identifier
TBS: Transport Block Size
TCP: Transmission Control Protocol
TDD: Time Division Duplex
TDRA: Time Domain Resource Allocation
TPC: Transmit Power Control
TRP: Transmission/Reception Point
TX: Transmission/Transmit
UAC: Unified Access Control
UDM: Unified Data Management
UDR: User Data Repository
UE: User Equipment
UI: User Input
UL: Uplink (from UE to BS)
UMTS: Universal Mobile Telecommunication System
UPF: User Plane Function
URLLC: Ultra-Reliable Low-Latency Communication
URM: Universal Resources Management
URSP: UE Route Selection Policy
USIM: User Subscriber Identity Module
UTRA: Universal Mobile Telecommunications System Terrestrial Radio Access
Wi-Fi: Wireless Local Area Network (WLAN) RAT based on the Institute of Electrical and Electronics Engineers' (IEEE) 802.11 standards
WLAN: Wireless LAN
ZP: Zero Power

### Terms

The following is a glossary of terms that may appear in the present application:

Memory Medium—Any of various types of memory devices or storage devices. The term “memory medium” is intended to include an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may comprise other types of memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer system for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Programmable Hardware Element—Includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.

Computer System (or Computer)—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” may be broadly defined to encompass any device (or combination of devices) having at least one processor that executes instructions from a memory medium.

User Equipment (UE) (or “UE Device”)—any of various types of computer systems devices which perform wireless communications. Also referred to as wireless communication devices, many of which may be mobile and/or portable. Examples of UE devices include mobile telephones or smart phones (e.g., iPhone™, Android™-based phones) and tablet computers such as iPad™, Samsung Galaxy™, etc., gaming devices (e.g. Sony Play Station™) Microsoft XBox™, etc.), portable gaming devices (e.g., Nintendo DS™, PlayStation Portable™, Gameboy Advance™, iPod™), laptops, wearable devices (e.g. smart watch, smart glasses), PDAs, portable Internet devices, music players, data storage devices, or other handheld devices, unmanned aerial vehicles (e.g., drones) and unmanned aerial controllers, etc. Various other types of devices would fall into this category if they include Wi-Fi or both cellular and Wi-Fi communication capabilities and/or other wireless communication capabilities, for example over short-range radio access technologies (SRATs) such as BLUETOOTH™, etc. In general, the term “UE” or “UE device” may be broadly defined to encompass any electronic, computing, and/or telecommunications device (or combination of devices) which is capable of wireless communication and may also be portable/mobile.

Wireless Device (or wireless communication device)—any of various types of computer systems devices which performs wireless communications using WLAN communications, SRAT communications, Wi-Fi communications and the like. As used herein, the term “wireless device” may refer to a UE device, as defined above, or to a stationary device, such as a stationary wireless client or a wireless base station. For example a wireless device may be any type of wireless station of an 802.11 system, such as an access point (AP) or a client station (UE), or any type of wireless station of a cellular communication system communicating according to a cellular radio access technology (e.g. 5G NR, LTE, CDMA, GSM), such as a base station or a cellular telephone, for example.

Communication Device—any of various types of computer systems or devices that perform communications, where the communications can be wired or wireless. A communication device can be portable (or mobile) or may be stationary or fixed at a certain location. A wireless device is an example of a communication device. A UE is another example of a communication device.

Base Station (BS)—The term “Base Station” has the full breadth of its ordinary meaning, and at least includes a wireless communication station installed at a fixed location and used to communicate as part of a wireless telephone system or radio system.

Processor—refers to various elements (e.g. circuits) or combinations of elements that are capable of performing a function in a device, e.g. in a user equipment device or in a cellular network device. Processors may include, for example: general purpose processors and associated memory, portions or circuits of individual processor cores, entire processor cores or processing circuit cores, processing circuit arrays or processor arrays, circuits such as ASICs (Application Specific Integrated Circuits), programmable hardware elements such as a field programmable gate array (FPGA), as well as any of various combinations of the above.

Channel—a medium used to convey information from a sender (transmitter) to a receiver. It should be noted that since characteristics of the term “channel” may differ according to different wireless protocols, the term “channel” as used herein may be considered as being used in a manner that is consistent with the standard of the type of device with reference to which the term is used. In some standards, channel widths may be variable (e.g., depending on device capability, band conditions, etc.). For example, LTE may support scalable channel bandwidths from 1.4 MHz to 20 MHz. In contrast, WLAN channels may be 22 MHz wide while Bluetooth channels may be 1 Mhz wide. Other protocols and standards may include different definitions of channels. Furthermore, some standards may define and use multiple types of channels, e.g., different channels for uplink or downlink and/or different channels for different uses such as data, control information, etc.

Band (or Frequency Band)—The term “band” has the full breadth of its ordinary meaning, and at least includes a section of spectrum (e.g., radio frequency spectrum) in which channels are used or set aside for the same purpose. Furthermore, “frequency band” is used to denote any interval in the frequency domain, delimited by a lower frequency and an upper frequency. The term may refer to a radio band or an interval of some other spectrum. A radio communications signal may occupy a range of frequencies over which (or where) the signal is carried. Such a frequency range is also referred to as the bandwidth of the signal. Thus, bandwidth refers to the difference between the upper frequency and lower frequency in a continuous band of frequencies. A frequency band may represent one communication channel or it may be subdivided into multiple communication channels. Allocation of radio frequency ranges to different uses is a major function of radio spectrum allocation. For example, in 5G NR, the operating frequency bands are categorized in two groups. More specifically, per 3GPP Release 15, frequency bands are designated for different frequency ranges (FR) and are defined as FR1 and FR2, with FR1 encompassing the 410 MHz-7125 MHz range and FR2 encompassing the 24250 MHz-52600 MHz range.

Wi-Fi—The term “Wi-Fi” has the full breadth of its ordinary meaning, and at least includes a wireless communication network or RAT that is serviced by wireless LAN (WLAN) access points and which provides connectivity through these access points to the Internet. Most modern Wi-Fi networks (or WLAN networks) are based on IEEE 802.11 standards and are marketed under the name “Wi-Fi”. A Wi-Fi (WLAN) network is different from a cellular network.

Automatically—refers to an action or operation performed by a computer system (e.g., software executed by the computer system) or device (e.g., circuitry, programmable hardware elements, ASICs, etc.), without user input directly specifying or performing the action or operation. Thus the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

Approximately—refers to a value that is almost correct or exact. For example, approximately may refer to a value that is within 1 to 10 percent of the exact (or desired) value. It should be noted, however, that the actual threshold value (or tolerance) may be application dependent. For example, in some embodiments, “approximately” may mean within 0.1% of some specified or desired value, while in various other embodiments, the threshold may be, for example, 2%, 3%, 5%, and so forth, as desired or as required by the particular application.

Concurrent—refers to parallel execution or performance, where tasks, processes, or programs are performed in an at least partially overlapping manner. For example, concurrency may be implemented using “strong” or strict parallelism, where tasks are performed (at least partially) in parallel on respective computational elements, or using “weak parallelism”, where the tasks are performed in an interleaved manner, e.g., by time multiplexing of execution threads.

Station (STA)—The term “station” herein refers to any device that has the capability of communicating wirelessly, e.g. by using the 802.11 protocol. A station may be a laptop, a desktop PC, PDA, access point or Wi-Fi phone or any type of device similar to a UE. An STA may be fixed, mobile, portable or wearable. Generally in wireless networking terminology, a station (STA) broadly encompasses any device with wireless communication capabilities, and the terms station (STA), wireless client (UE) and node (BS) are therefore often used interchangeably.

Configured to—Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Transmission Scheduling—Refers to the scheduling of transmissions, such as wireless transmissions. In some implementations of cellular radio communications, signal and data transmissions may be organized according to designated time units of specific duration during which transmissions take place. As used herein, the term “slot” has the full extent of its ordinary meaning, and at least refers to a smallest (or minimum) scheduling time unit in wireless communications. For example, in 3GPP LTE, transmissions are divided into radio frames, each radio frame being of equal (time) duration (e.g. 10 ms). A radio frame in 3GPP LTE may be further divided into a specified number of (e.g. ten) subframes, each subframe being of equal time duration, with the subframes designated as the smallest (minimum) scheduling unit, or the designated time unit for a transmission. Thus, in a 3GPP LTE example, a “subframe” may be considered an example of a “slot” as defined above. Similarly, a smallest (or minimum) scheduling time unit for 5G NR (or NR, for short) transmissions is referred to as a “slot”. In different communication protocols the smallest (or minimum) scheduling time unit may also be named differently.

Resources—The term “resource” has the full extent of its ordinary meaning and may refer to frequency resources and time resources used during wireless communications. As used herein, a resource element (RE) refers to a specific amount or quantity of a resource. For example, in the context of a time resource, a resource element may be a time period of specific length. In the context of a frequency resource, a resource element may be a specific frequency bandwidth, or a specific amount of frequency bandwidth, which may be centered on a specific frequency. As one specific example, a resource element may refer to a resource unit of 1 symbol (in reference to a time resource, e.g. a time period of specific length) per 1 subcarrier (in reference to a frequency resource, e.g. a specific frequency bandwidth, which may be centered on a specific frequency). A resource element group (REG) has the full extent of its ordinary meaning and at least refers to a specified number of consecutive resource elements. In some implementations, a resource element group may not include resource elements reserved for reference signals. A control channel element (CCE) refers to a group of a specified number of consecutive REGs. A resource block (RB) refers to a specified number of resource elements made up of a specified number of subcarriers per specified number of symbols. Each RB may include a specified number of subcarriers. A resource block group (RBG) refers to a unit including multiple RBs. The number of RBs within one RBG may differ depending on the system bandwidth.

Bandwidth Part (BWP)—A carrier bandwidth part (BWP) is a contiguous set of physical resource blocks selected from a contiguous subset of the common resource blocks for a given numerology on a given carrier. For downlink, a UE may be configured with up to a specified number of carrier BWPs (e.g. four BWPs, per some specifications), with one BWP per carrier active at a given time (per some specifications). For uplink, the UE may similarly be configured with up to several (e.g. four) carrier BWPs, with one BWP per carrier active at a given time (per some specifications). If a UE is configured with a supplementary uplink, then the UE may be additionally configured with up to the specified number (e.g. four) carrier BWPs in the supplementary uplink, with one carrier BWP active at a given time (per some specifications).

Multi-cell Arrangements—A Master node is defined as a node (radio access node) that provides control plane connection to the core network in case of multi radio dual connectivity (MR-DC). A master node may be a master eNB (3GPP LTE) or a master gNB (3GPP NR), for example. A secondary node is defined as a radio access node with no control plane connection to the core network, providing additional resources to the UE in case of MR-DC. A Master Cell group (MCG) is defined as a group of serving cells associated with the Master Node, including the primary cell (PCell) and optionally one or more secondary cells (SCell). A Secondary Cell group (SCG) is defined as a group of serving cells associated with the Secondary Node, including a special cell, namely a primary cell of the SCG (PSCell), and optionally including one or more SCells. A UE may typically apply radio link monitoring to the PCell. If the UE is configured with an SCG then the UE may also apply radio link monitoring to the PSCell. Radio link monitoring is generally applied to the active BWPs and the UE is not required to monitor inactive BWPs. The PCell is used to initiate initial access, and the UE may communicate with the PCell and the SCell via Carrier Aggregation (CA). Currently Amended capability means a UE may receive and/or transmit to and/or from multiple cells. The UE initially connects to the PCell, and one or more SCells may be configured for the UE once the UE is in a connected state.

Core Network (CN)—Core network is defined as a part of a 3GPP system which is independent of the connection technology (e.g. the Radio Access Technology, RAT) of the UEs. The UEs may connect to the core network via a radio access network, RAN, which may be RAT-specific.

Downlink Control Information (DCI)—In 3GPP communications, DCI is transmitted to a mobile device or UE (e.g., by a serving base station in the network) and contains multiple different fields. Each field is used to configure one part or aspect of a scheduled communication(s) of the device. To put it another way, each field in the DCI may correspond to a specific communication parameter or parameters configuring a corresponding aspect of the scheduled communication(s) of the device. By decoding the DCI, the UE obtains all the configuring parameters or parameter values according to the fields in the DCI, thereby obtaining all the information about the scheduled communication(s) and subsequently performing the scheduled communication(s) according to those parameters/parameter values.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112, paragraph six, interpretation for that component.

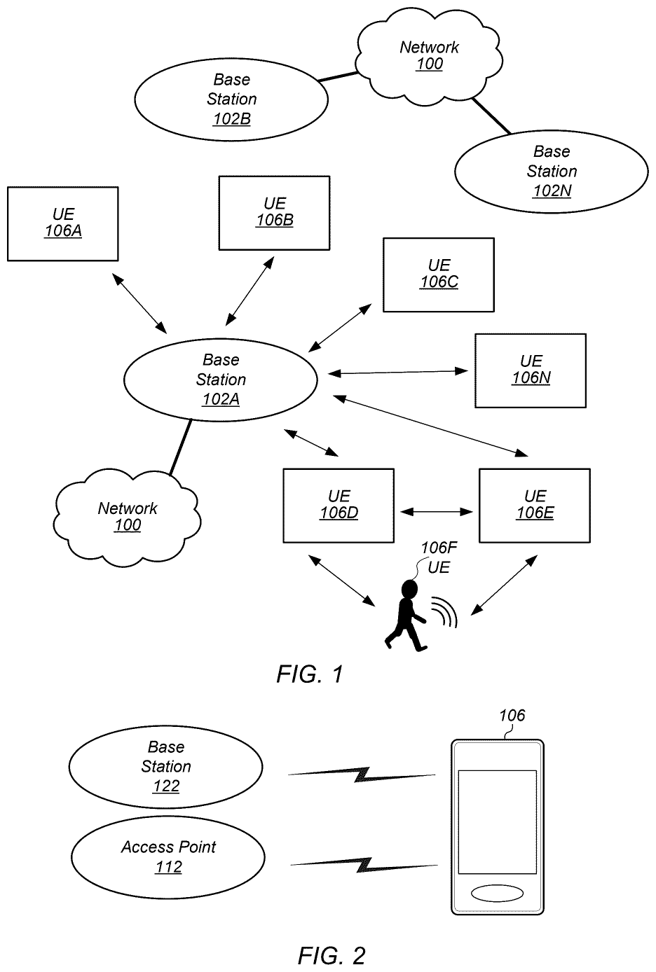

### FIGS. 1 and 2—Exemplary Communication Systems

FIG. 1 illustrates an exemplary (and simplified) wireless communication system, according to some embodiments. It is noted that the system of FIG. 1 is merely one example of a possible system, and embodiments may be implemented in any of various systems, as desired.

As shown, the exemplary wireless communication system includes base stations 102A through 102N, also collectively referred to as base station(s) 102 or base station 102. As shown in FIG. 1, base station 102A communicates over a transmission medium with one or more user devices 106A through 106N. Each of the user devices may be referred to herein as a “user equipment” (UE) or UE device. Thus, the user devices 106A through 106N are referred to as UEs or UE devices, and are also collectively referred to as UE(s) 106 or UE 106.

The base station 102A may be a base transceiver station (BTS) or cell site, and may include hardware that enables wireless communication with the UEs 106A through 106N. The base station 102A may also be equipped to communicate with a network 100 (e.g., a core network of a cellular service provider, a telecommunication network such as a public switched telephone network (PSTN), and/or the Internet, neutral host or various CBRS (Citizens Broadband Radio Service) deployments, among various possibilities). Thus, the base station 102A may facilitate communication between the user devices 106 and/or between the user devices 106 and the network 100. In particular, the cellular base station 102A may provide UEs 106 with various telecommunication capabilities, such as voice, short message service (SMS) and/or data services. The communication area (or coverage area) of the base station 106 may be referred to as a “cell.” It is noted that “cell” may also refer to a logical identity for a given wireless communication coverage area at a given frequency. In general, any independent cellular wireless coverage area may be referred to as a “cell”. In such cases a base station may be situated at particular confluences of three cells. The base station, in this uniform topology, may serve three 120 degree beam width areas referenced as cells. Also, in case of carrier aggregation, small cells, relays, etc. may each represent a cell. Thus, in carrier aggregation in particular, there may be primary cells and secondary cells which may service at least partially overlapping coverage areas but on different respective frequencies. For example, a base station may serve any number of cells, and cells served by a base station may or may not be collocated (e.g. remote radio heads). As also used herein, from the perspective of UEs, a base station may sometimes be considered as representing the network insofar as uplink and downlink communications of the UE are concerned. Thus, a UE communicating with one or more base stations in the network may also be interpreted as the UE communicating with the network, and may further also be considered at least a part of the UE communicating on the network or over the network.

The base station(s) 102 and the user devices 106 may be configured to communicate over the transmission medium using any of various radio access technologies (RATs), also referred to as wireless communication technologies, or telecommunication standards, such as GSM, UMTS (WCDMA), LTE, LTE-Advanced (LTE-A), LAA/LTE-U, 5G-NR (NR, for short), 3GPP2 CDMA 2000 (e.g., 1xRTT, 1xEV-DO, HRPD, eHRPD), Wi-Fi, WiMAX etc. Note that if the base station 102A is implemented in the context of LTE, it may alternately be referred to as an ‘eNodeB’ or ‘eNB’. Similarly, if the base station 102A is implemented in the context of 5G NR, it may alternately be referred to as ‘gNodeB’ or ‘gNB’. In some embodiments, the base station 102 (e.g. an eNB in an LTE network or a gNB in an NR network) may communicate with at least one UE having the capability to transmit reference signals according to various embodiments disclosed herein. Depending on a given application or specific considerations, for convenience some of the various different RATs may be functionally grouped according to an overall defining characteristic. For example, all cellular RATs may be collectively considered as representative of a first (form/type of) RAT, while Wi-Fi communications may be considered as representative of a second RAT. In other cases, individual cellular RATs may be considered individually as different RATs. For example, when differentiating between cellular communications and Wi-Fi communications, “first RAT” may collectively refer to all cellular RATs under consideration, while “second RAT” may refer to Wi-Fi. Similarly, when applicable, different forms of Wi-Fi communications (e.g. over 2.4 GHz vs. over 5 GHz) may be considered as corresponding to different RATs. Furthermore, cellular communications performed according to a given RAT (e.g. LTE or NR) may be differentiated from each other on the basis of the frequency spectrum in which those communications are conducted. For example, LTE or NR communications may be performed over a primary licensed spectrum as well as over a secondary spectrum such as an unlicensed spectrum and/or spectrum that was assigned to private networks. Overall, the use of various terms and expressions will always be clearly indicated with respect to and within the context of the various applications/embodiments under consideration.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices 106 and/or between the user devices 106 and the network 100. In particular, the cellular base station 102A may provide UEs 106 with various telecommunication capabilities, such as voice, SMS and/or data services. UE 106 may be capable of communicating using multiple wireless communication standards. For example, a UE 106 might be configured to communicate using any or all of a 3GPP cellular communication standard (such as LTE or NR) or a 3GPP2 cellular communication standard (such as a cellular communication standard in the CDMA2000 family of cellular communication standards). Base station 102A and other similar base stations (such as base stations 102B . . . 102N) operating according to the same or a different cellular communication standard may thus be provided as one or more networks of cells, which may provide continuous or nearly continuous overlapping service to UE 106 and similar devices over a wide geographic area via one or more cellular communication standards.

Thus, while base station 102A may act as a “serving cell” for UEs 106A-106N as illustrated in FIG. 1, each one of UE(s) 106 may also be capable of receiving signals from (and may possibly be within communication range of) one or more other cells (possibly provided by base stations 102B-102N and/or any other base stations), which may be referred to as “neighboring cells”. Such cells may also be capable of facilitating communication in-between user devices 106 and/or between user devices 106 and the network 100. Such cells may include “macro” cells, “micro” cells, “pico” cells, and/or cells which provide any of various other granularities of service area size. For example, base stations 102A-102B illustrated in FIG. 1 may be macro cells, while base station 102N may be a micro cell. Other configurations are also possible.

In some embodiments, base station 102A may be a next generation base station, e.g., a 5G New Radio (5G NR) base station, or “gNB”. In some embodiments, a gNB may be connected to a legacy evolved packet core (EPC) network and/or to a NR core (NRC) network. In addition, a gNB cell may include one or more transmission and reception points (TRPs). In addition, a UE capable of operating according to 5G NR may be connected to one or more TRPs within one or more gNBs.

The UE 106 might also or alternatively be configured to communicate using WLAN, BLUETOOTH™, BLUETOOTH™ Low-Energy, one or more global navigational satellite systems (GNSS, e.g., GPS or GLONASS), one and/or more mobile television broadcasting standards (e.g., ATSC-M/H or DVB-H), etc. Other combinations of wireless communication standards (including more than two wireless communication standards) are also possible. Furthermore, the UE 106 may also communicate with Network 100, through one or more base stations or through other devices, stations, or any appliances not explicitly shown but considered to be part of Network 100. UE 106 communicating with a network may therefore be interpreted as the UE(s) 106 communicating with one or more network nodes considered to be a part of the network and which may interact with the UE(s) 106 to conduct communications with the UE(s) 106 and in some cases affect at least some of the communication parameters and/or use of communication resources of the UE(s) 106.

As also illustrated in FIG. 1, at least some of the UEs, e.g. UEs 106D and 106E may represent vehicles communicating with each other and with base station 102, e.g. via cellular communications such as 3GPP LTE and/or 5G-NR communications, for example. In addition, UE 106F may represent a pedestrian who is communicating and/or interacting in a similar manner with the vehicles represented by UEs 106D and 106E. Various embodiments of vehicles communicating in a network exemplified in FIG. 1 are disclosed, for example, in the context of vehicle-to-everything (V2X) communications such as the communications specified by certain versions of the 3GPP standard, among others.

FIG. 2 illustrates an exemplary user equipment 106 (e.g., one of UEs 106A through 106N) in communication with the base station 122 and an access point 112, according to some embodiments. The UE 106 may be a device with both cellular communication capability and non-cellular communication capability (e.g., BLUETOOTH™, Wi-Fi, and so forth) such as a mobile phone, a hand-held device, a computer or a tablet, or virtually any type of wireless device. The UE 106 may include a processor that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array) that is configured to perform any of the method embodiments described herein, or any portion of any of the method embodiments described herein. The UE 106 may be configured to communicate using any of multiple wireless communication protocols. For example, the UE 106 may be configured to communicate using two or more of CDMA2000, LTE, LTE-A, NR, WLAN, or GNSS. Other combinations of wireless communication standards are also possible.

The UE 106 may include one or more antennas for communicating using one or more wireless communication protocols according to one or more RAT standards, e.g. those previously mentioned above. In some embodiments, the UE 106 may share one or more parts of a receive chain and/or transmit chain between multiple wireless communication standards. The shared radio may include a single antenna, or may include multiple antennas (e.g., for MIMO) for performing wireless communications. Alternatively, the UE 106 may include separate transmit and/or receive chains (e.g., including separate antennas and other radio components) for each wireless communication protocol with which it is configured to communicate. As another alternative, the UE 106 may include one or more radios or radio circuitry which are shared between multiple wireless communication protocols, and one or more radios which are used exclusively by a single wireless communication protocol. For example, the UE 106 may include radio circuitries for communicating using either of LTE or CDMA2000 1xRTT or NR, and separate radios for communicating using each of Wi-Fi and BLUETOOTH™. Other configurations are also possible.

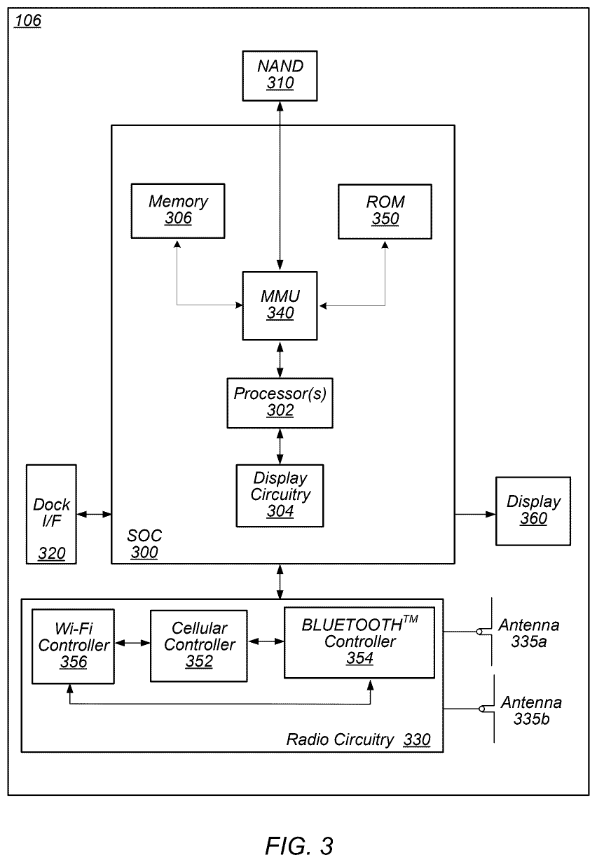

### FIG. 3—Block Diagram of an Exemplary UE

FIG. 3 illustrates a block diagram of an exemplary UE 106, according to some embodiments. As shown, the UE 106 may include a system on chip (SOC) 300, which may include various elements/components for various purposes. For example, as shown, the SOC 300 may include processor(s) 302 which may execute program instructions for the UE 106 and display circuitry 304 which may perform graphics processing and provide display signals to the display 360. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, radio circuitry 330, connector I/F 320, and/or display 360. The MMU 340 may be configured to perform memory protection and page table translation or set up. In some embodiments, the MMU 340 may be included as a portion of the processor(s) 302.

As shown, the SOC 300 may be coupled to various other circuits of the UE 106. For example, the UE 106 may include various types of memory (e.g., including NAND flash 310), a connector interface 320 (e.g., for coupling to the computer system), the display 360, and wireless communication circuitry (e.g., for LTE, LTE-A, NR, CDMA2000, BLUETOOTH™, Wi-Fi, GPS, etc.). The UE device 106 may include at least one antenna (e.g. 335a), and possibly multiple antennas (e.g. illustrated by antennas 335a and 335b), for performing wireless communication with base stations and/or other devices. Antennas 335a and 335b are shown by way of example, and UE device 106 may include fewer or more antennas. Overall, the one or more antennas are collectively referred to as antenna(s) 335. For example, the UE device 106 may use antenna(s) 335 to perform the wireless communication with the aid of radio circuitry 330. As noted above, the UE may be configured to communicate wirelessly using multiple wireless communication standards in some embodiments.

As further described herein, the UE 106 (and/or base station 102) may include hardware and software components for implementing methods for at least UE 106 to transmit reference signals according to various embodiments disclosed herein. The processor(s) 302 of the UE device 106 may be configured to implement part or all of the methods described herein, e.g., by executing program instructions stored on a memory medium (e.g., a non-transitory computer-readable memory medium). In other embodiments, processor(s) 302 may be configured as a programmable hardware element, such as an FPGA (Field Programmable Gate Array), or as an ASIC (Application Specific Integrated Circuit). Furthermore, processor(s) 302 may be coupled to and/or may interoperate with other components as shown in FIG. 3, to implement communications by UE 106 to transmit reference signals according to various embodiments disclosed herein. Specifically, processor(s) 302 may be coupled to and/or may interoperate with other components as shown in FIG. 3 to facilitate UE 106 communicating in a manner that seeks to optimize RAT selection. Processor(s) 302 may also implement various other applications and/or end-user applications running on UE 106.

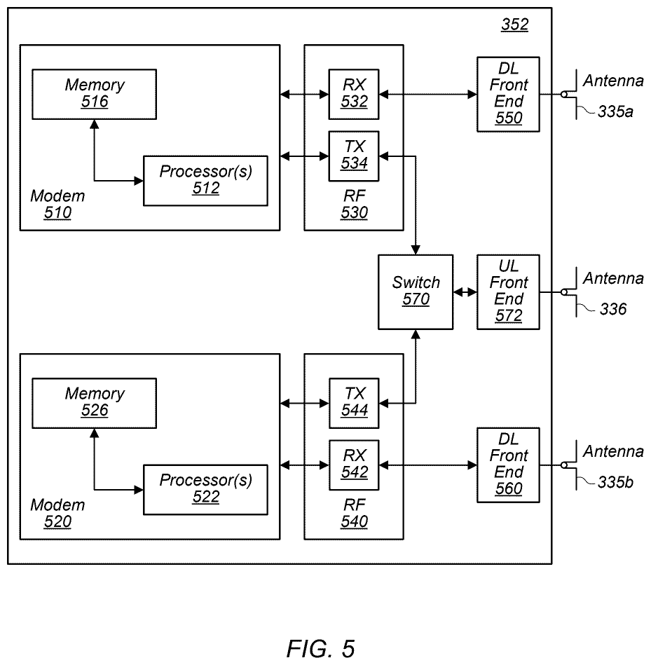

In some embodiments, radio circuitry 330 may include separate controllers dedicated to controlling communications for various respective RATs and/or RAT standards. For example, as shown in FIG. 3, radio circuitry 330 may include a Wi-Fi controller 356, a cellular controller (e.g. LTE and/or NR controller) 352, and BLUETOOTH™ controller 354, and according to at least some embodiments, one or more or all of these controllers may be implemented as respective integrated circuits (ICs or chips, for short) in communication with each other and with SOC 300 (e.g. with processor(s) 302). For example, Wi-Fi controller 356 may communicate with cellular controller 352 over a cell-ISM link or WCI interface, and/or BLUETOOTH™ controller 354 may communicate with cellular controller 352 over a cell-ISM link, etc. While three separate controllers are illustrated within radio circuitry 330, other embodiments may have fewer or more similar controllers for various different RATs and/or RAT standards that may be implemented in UE device 106. For example, at least one exemplary block diagram illustrative of some embodiments of cellular controller 352 is shown in FIG. 5 and will be further described below.

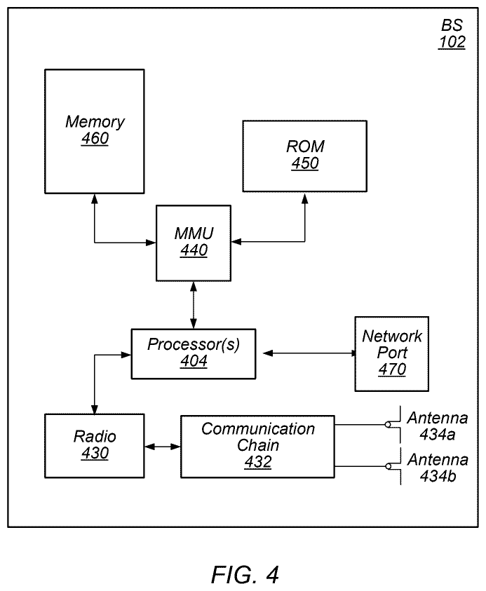

### FIG. 4—Block Diagram of an Exemplary Base Station

FIG. 4 illustrates a block diagram of an exemplary base station 102, according to some embodiments. It is noted that the base station of FIG. 4 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 106, access to the telephone network as described above in FIGS. 1 and 2. The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

The base station 102 may include at least one antenna 434a, and possibly multiple antennas (e.g. illustrated by antennas 434a and 434b), for performing wireless communication with mobile devices and/or other devices. Antennas 434a and 434b are shown by way of example, and base station 102 may include fewer or more antennas. Overall, the one or more antennas, which may include antenna 434a and/or antenna 434b, are collectively referred to as antenna 434 or antenna(s) 434. Antenna(s) 434 may be configured to operate as a wireless transceiver and may be further configured to communicate with UE devices 106 via radio circuitry 430. The antenna(s) 434 communicates with the radio 430 via communication chain 432. Communication chain 432 may be a receive chain, a transmit chain or both. The radio circuitry 430 may be designed to communicate via various wireless telecommunication standards, including, but not limited to, LTE, LTE-A, 5G-NR (NR) WCDMA, CDMA2000, etc. The processor(s) 404 of the base station 102 may be configured to implement part or all of the methods described herein, e.g., by executing program instructions stored on a memory medium (e.g., a non-transitory computer-readable memory medium). Alternatively, the processor(s) 404 may be configured as a programmable hardware element(s), such as an FPGA (Field Programmable Gate Array), or as an ASIC (Application Specific Integrated Circuit), or a combination thereof. In the case of certain RATs, for example Wi-Fi, base station 102 may be designed as an access point (AP), in which case network port 470 may be implemented to provide access to a wide area network and/or local area network(s), e.g. it may include at least one Ethernet port, and radio 430 may be designed to communicate according to the Wi-Fi standard.

### FIG. 5—Exemplary Cellular Communication Circuitry

FIG. 5 illustrates an exemplary simplified block diagram illustrative of cellular controller 352, according to some embodiments. It is noted that the block diagram of the cellular communication circuitry of FIG. 5 is only one example of a possible cellular communication circuit; other circuits, such as circuits including or coupled to sufficient antennas for different RATs to perform uplink activities using separate antennas, or circuits including or coupled to fewer antennas, e.g., that may be shared among multiple RATs, are also possible. According to some embodiments, cellular communication circuitry 352 may be included in a communication device, such as communication device 106 described above. As noted above, communication device 106 may be a user equipment (UE) device, a mobile device or mobile station, a wireless device or wireless station, a desktop computer or computing device, a mobile computing device (e.g., a laptop, notebook, or portable computing device), a tablet and/or a combination of devices, among other devices.

The cellular communication circuitry 352 may couple (e.g., communicatively; directly or indirectly) to one or more antennas, such as antennas 335a-b and 336 as shown. In some embodiments, cellular communication circuitry 352 may include dedicated receive chains (including and/or coupled to (e.g., communicatively; directly or indirectly) dedicated processors and/or radios) for multiple RATs (e.g., a first receive chain for LTE and a second receive chain for 5G NR). For example, as shown in FIG. 5, cellular communication circuitry 352 may include a first modem 510 and a second modem 520. The first modem 510 may be configured for communications according to a first RAT, e.g., such as LTE or LTE-A, and the second modem 520 may be configured for communications according to a second RAT, e.g., such as 5G NR.

As shown, the first modem 510 may include one or more processors 512 and a memory 516 in communication with processors 512. Modem 510 may be in communication with a radio frequency (RF) front end 530. RF front end 530 may include circuitry for transmitting and receiving radio signals. For example, RF front end 530 may include receive circuitry (RX) 532 and transmit circuitry (TX) 534. In some embodiments, receive circuitry 532 may be in communication with downlink (DL) front end 550, which may include circuitry for receiving radio signals via antenna 335a.

Similarly, the second modem 520 may include one or more processors 522 and a memory 526 in communication with processors 522. Modem 520 may be in communication with an RF front end 540. RF front end 540 may include circuitry for transmitting and receiving radio signals. For example, RF front end 540 may include receive circuitry 542 and transmit circuitry 544. In some embodiments, receive circuitry 542 may be in communication with DL front end 560, which may include circuitry for receiving radio signals via antenna 335b.

In some embodiments, a switch 570 may couple transmit circuitry 534 to uplink (UL) front end 572. In addition, switch 570 may couple transmit circuitry 544 to UL front end 572. UL front end 572 may include circuitry for transmitting radio signals via antenna 336. Thus, when cellular communication circuitry 352 receives instructions to transmit according to the first RAT (e.g., as supported via the first modem 510), switch 570 may be switched to a first state that allows the first modem 510 to transmit signals according to the first RAT (e.g., via a transmit chain that includes transmit circuitry 534 and UL front end 572). Similarly, when cellular communication circuitry 352 receives instructions to transmit according to the second RAT (e.g., as supported via the second modem 520), switch 570 may be switched to a second state that allows the second modem 520 to transmit signals according to the second RAT (e.g., via a transmit chain that includes transmit circuitry 544 and UL front end 572).

As described herein, the first modem 510 and/or the second modem 520 may include hardware and software components for implementing any of the various features and techniques described herein. The processors 512, 522 may be configured to implement part or all of the features described herein, e.g., by executing program instructions stored on a memory medium (e.g., a non-transitory computer-readable memory medium). Alternatively (or in addition), processors 512, 522 may be configured as a programmable hardware element, such as an FPGA (Field Programmable Gate Array), or as an ASIC (Application Specific Integrated Circuit). Alternatively (or in addition) the processors 512, 522, in conjunction with one or more of the other components 530, 532, 534, 540, 542, 544, 550, 570, 572, 335 and 336 may be configured to implement part or all of the features described herein.

In addition, as described herein, processors 512, 522 may include one or more components. Thus, processors 512, 522 may include one or more integrated circuits (ICs) that are configured to perform the functions of processors 512, 522. In addition, each integrated circuit may include circuitry (e.g., first circuitry, second circuitry, etc.) configured to perform the functions of processors 512, 522.

In some embodiments, the cellular communication circuitry 352 may include only one transmit/receive chain. For example, the cellular communication circuitry 352 may not include the modem 520, the RF front end 540, the DL front end 560, and/or the antenna 335b. As another example, the cellular communication circuitry 352 may not include the modem 510, the RF front end 530, the DL front end 550, and/or the antenna 335a. In some embodiments, the cellular communication circuitry 352 may also not include the switch 570, and the RF front end 530 or the RF front end 540 may be in communication, e.g., directly, with the UL front end 572

### Uplink (UL) Transmit (TX) Switching

During wireless communications, e.g., 3GPP NR communications, a base station may trigger a UE to switch the UE's UL transmission from one or more current frequency bands, also referred to simply as bands, to one or more different target bands. This may part of a carrier aggregation operation, for example. Switching period or switching gap refers to the delay, or time period/gap, during which the UE makes adjustments, for example to its RF chain operation, to implement the switching from transmitting on the current band(s) to transmitting on the different (target) band(s). During the switching period, no UL transmissions take place on any of the bands involved in the switching, e.g., the current band(s) and the different target band(s). In some cases, a UE may also indicate/report that no DL transmissions may take place on the involved bands, that is, DL transmissions may also be interrupted during the UL TX switching period.

In the current 3GPP specification, the switching period location for UL TX switching is indicated by the RRC parameter “uplinkTxSwitchingPeriodLocation” in “ServingCellConfig”. This parameter indicates whether the location of the UL TX switching period is configured in the given uplink carrier in case of inter-band UL CA, supplementary uplink (SUL), or E-UTRA NR Dual Connectivity under a 5G core network (NGEN-DC). In case of NGEN-DC, the network always configures this field to TRUE for an NR carrier (e.g., with NGEN-DC, the UL switching period always occurs on the NR carrier). In case of inter-band UL CA or SUL, for dynamic uplink TX switching between two bands with two or more uplink carriers, the network configures this field to TRUE for the uplink carrier(s) on one band and configures this field to FALSE for the uplink carrier(s) on the other band. This field is set to the same value for the carriers on the same band.

According to current specifications, UL transmissions are not supported on the bands/carriers (involved in the switching) for the entire duration of the switching period or switching period location (it should be noted that as used herein, “switching period location” refers to the occurrence of the switching period on a signal transmission/reception timeline.) For example, if there is switching from band A to band B and if the switching period location is set to “True” for either band A or band B, then UL transmissions are not supported on band A and band B during the switching period (location).

Furthermore, the UE may report “uplinkTxSwitching-DL-Interruption-r16”, which indicates that a DL interruption on the band will occur during the UL TX switching. The UE is not allowed to set this field for the band combination of SUL band+TDD band, for which no DL interruption is allowed. The field is encoded as a bit map, where bit N is set to “1” if DL interruption on band N will occur during uplink TX switching. The leading/leftmost bit (bit 0) corresponds to the first band of this band combination, the next bit corresponds to the second band of this band combination and so on. The capability is not applicable to the following band combinations, in which DL reception interruption is not allowed:
TDD+TDD CA with the same UL-DL pattern; and
TDD+TDD EN-DC with the same UL-DL pattern.

### Scheduling Gap/Period and Switching Gap/Period

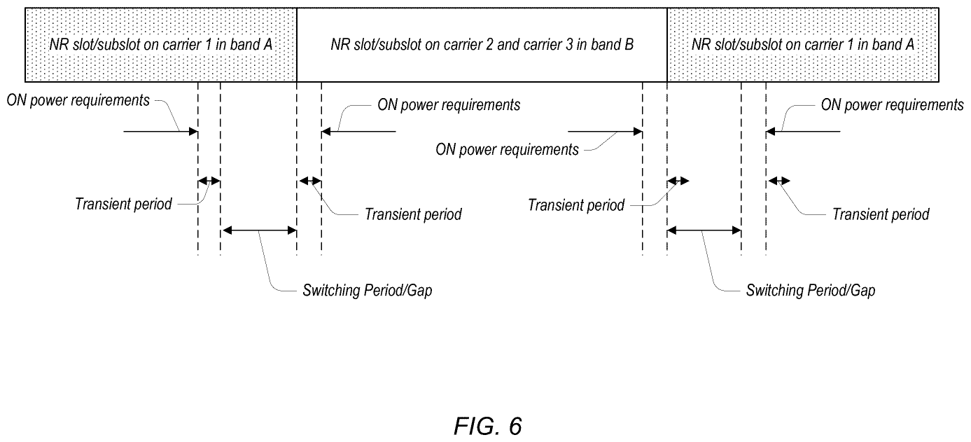

A scheduling gap or period may identify the time period/gap between reception(s)/transmission(s) on two different bands. The switching period/gap location is currently indicated/specified for cases where the duration of the scheduling gap is shorter than the duration of the switching gap between the initial (current) band/carrier used before UL TX switching and the final (target) band/carrier used after the UL Tx switching. This is illustrated in FIG. 6, which shows an exemplary timing diagram with band A set to “true” for the switching period location, and no scheduling gap between the two bands for UL TX switching.

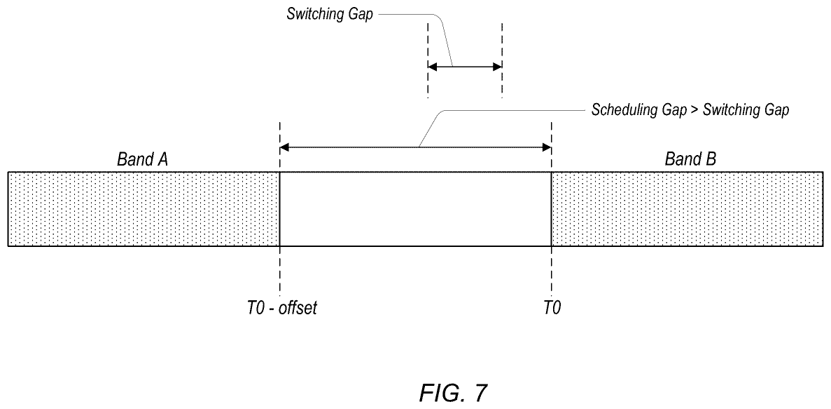

However, the switching period location is currently not indicated/specified for cases where the scheduling gap is longer than or equal to the duration of the switching gap between the initial (current) band/carrier used before UL TX switching and the final (target) band/carrier used after the UL TX switching, as shown in exemplary FIG. 7. As shown in FIG. 7, the scheduling gap is defined by a time period, or offset, between band A and band B, and located between time points T0 and T0-offset. When the scheduling gap is longer than or equal to the duration of the switching gap between the initial (current) band/carrier used before UL TX switching and the final (target) band/carrier used after the UL TX switching, the exact location of switching period is not indicated/specified because no UL transmissions take place during the scheduling gap. However, issues may arise regarding DL transmissions when a DL interruption is reported by the UE for the band(s) or band combination involved in the UL TX switching. From the perspective of the network, if the specific location is not known and may be anywhere within the scheduling gap, then the network may be unable to schedule DL transmissions during the entire scheduling gap when a DL interruption is reported by the UE for those bands.

It is therefore desirable to specify the switching period location even for cases where the scheduling gap is longer than or equal to the duration of the switching gap. As disclosed herein, various solutions are proposed for configuring and/or determining the switching period location for the case(s) where the scheduling gap (duration) is long enough to contain the switching gap (duration) for UL TX switching between the initial (current) band/carrier used prior to the UL TX switching and the final (target) band/carrier used after the UL TX switching.

### High-Level Overview for Determining UL Tx Switching Period Location

According to various embodiments, the switching period location may be indicated/defined for cases where the scheduling gap (time period) is greater than or equal to the switching gap (time period).

In some embodiments, if the UE reports:
A DL interruption on at least one band included in the UL TX switching (for example, the UE may indicate this via the parameter “uplink TxSwitching-DL-Interruption-r16”); and
A switching period per band pair per band combination (for example, the UE may indicate this via the parameter “uplinkTxSwitchingPeriod-r16/uplinkTxSwitchingPeriod2T2T-r17”), and
if the scheduling gap duration between the initial (current) bands/carriers used before UL TX switching and the final (target) bands/carriers used after the UL Tx switching is longer than the switching gap duration, then the location of the switching period location may be indicated as explicitly or implicitly configured or specified in the 3GPP specification.

If no DL interruption on the bands involved in UL TX switching is reported by the UE, then the switching period location may be identified/determined by the UE.

In some embodiments, the UE may report to the network, e.g., to a serving base station, whether the UE has the capability to support the switching period location configured in the specification. Accordingly, a new parameter for indicating this capability may be established. For example, a parameter, “uplinkTxSwitchingPeriod-new,” may be added under the UE capability “ULTxSwitchingBandPair-r16, ULTxSwitchingBandPair-v1700”. If no such capability it reported by the UE, then the determination of the switching period location may be identified/determined by the UE.

### First Solution

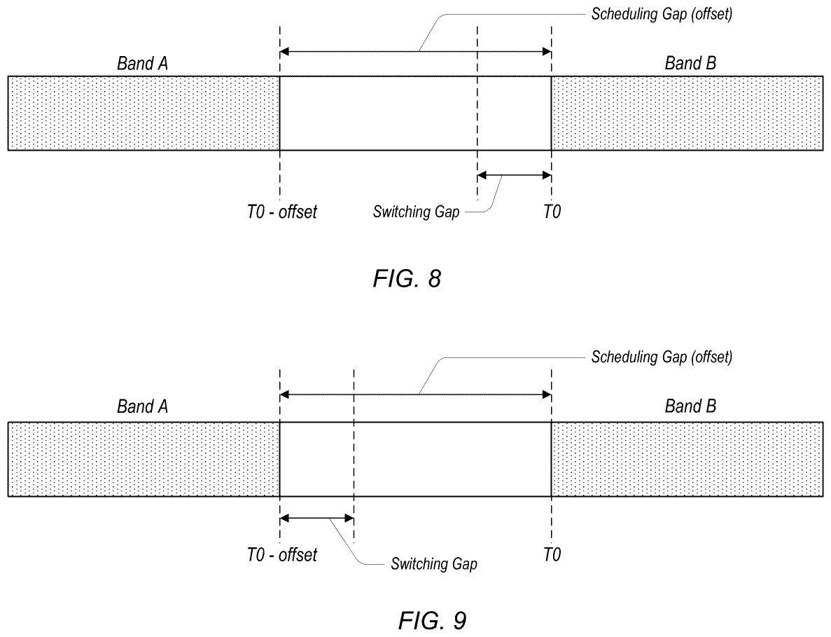

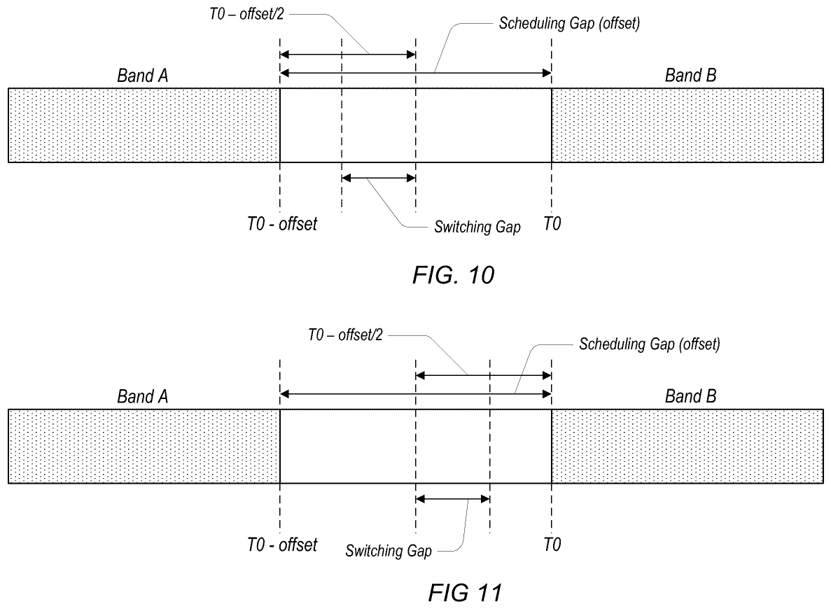

According to a first solution, the UE may be explicitly configured with a switching period location. This explicit configuration may specify the switching period location according to a variety of options.
Option 1: the switching period/gap location may end at the start of the UL transmission following the UL TX switching at time point T0 as shown in FIG. 8. As show in FIG. 8, the switching gap/period ends where the scheduling gap/period also ends. In other words, the switching gap location and scheduling gap location may both end at a same point in time at the start of the UL transmission following the UL TX switching.
Option 2: the switching period location may start at the start at the start of the scheduling gap, T0-offset, as shown in FIG. 9.
Option 3: the switching period location may end at the start of a point in time defined by T0-offset/2, as shown in FIG. 10. In other words, the scheduling gap location may end at the midway point of the scheduling gap.
Option 4: the switching period location may start a at the start of a point in time defined by T0-offset/2, as shown in FIG. 10. In other words, the scheduling gap location may start at the midway point of the scheduling gap, as shown in FIG. 11.

### Second Solution

According to a second solution, the UE may determine the switching gap location based on the existing switching location parameter, “uplinkTxSwitchingPeriodLocation,” which, as previously noted, is currently used for cases where the duration of the scheduling gap is shorter than the duration of the switching gap between the initial (current) band/carrier used before UL TX switching and the final (target) band/carrier used after the UL Tx switching.

In some embodiments, for a band pair:
If the switching location parameter identifies the initial band (used prior to UL TX switching), then the switching period location may start at the start of the scheduling gap. That is, the switching period location may start at T0-offset, e.g., as previously shown in FIG. 9.
If the switching location parameter identifies the final band (used after UL TX switching), then the switching period location may end at the end of the scheduling gap. That is, the switching period location may end at T0, e.g., as previously shown in FIG. 8.

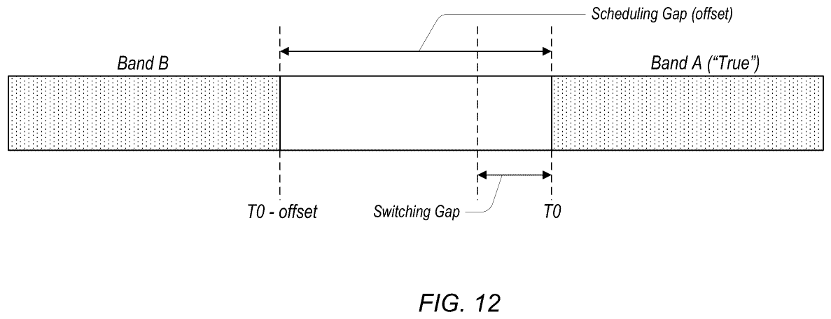

For example, referring to FIG. 12, for band pair A-B, if the switching location parameter is set to “TRUE” for band A, then the switching period location is determined, as shown in FIG. 12.

### Third Solution

According to a third solution, the UE may determine the switching gap location based on the priority configured for each band within a band combination. Based on the configured priority for a band pair:
If the priority indicates that the initial band(s) (used prior to UL TX switching) have a lower priority relative to the final band(s) (used after the UL TX switching), then the switching period location may start at the start of the scheduling gap/period. That is, the location of the switching period/gap may start at T0-offset, e.g., as previously shown in FIG. 9.
If the priority indicates that the final band(s) (used after UL TX switching) have a lower priority relative to the final band(s) (used prior to the UL TX switching), then the switching period location may end at the end of the scheduling gap/period. That is, the location of the switching period/gap may end at T0, e.g., as previously shown in FIGS. 8 and 12.

### Fourth Solution

According to a fourth solution, the switching period location may be fixed, e.g., in the 3GPP specification, and applied when:
The UE reports:
   A DL interruption on at least one band among the band combination for UL TX switching (for example via the parameter “uplinkTxSwitching-DL-Interruption-r16”, as previously mentioned), and
   A Switching period per band pair per band combination (for example via the parameter “uplinkTxSwitchingPeriod-r16/uplinkTxSwitchingPeriod2T2T-r17”, as previously mentioned); and
the scheduling gap duration between the initial bands/carriers used before UL TX switching and the final bands/carriers used after the UL TX switching is longer than the switching gap duration.

### Additional Considerations

In some embodiments, the switching period location may be specified, and not left up to UE implementation, for any of the following conditions:
When the UE reports DL interruption on all the bands within a band combination;
When the UE reports DL interruption on at least one band within a band combination;
When the UE reports DL interruption on all bands involved in a given switching instance; and
When the UE reports DL interruption on at least one band that is involved in a given switching instance.

### Exemplary Method for UL Tx Switching

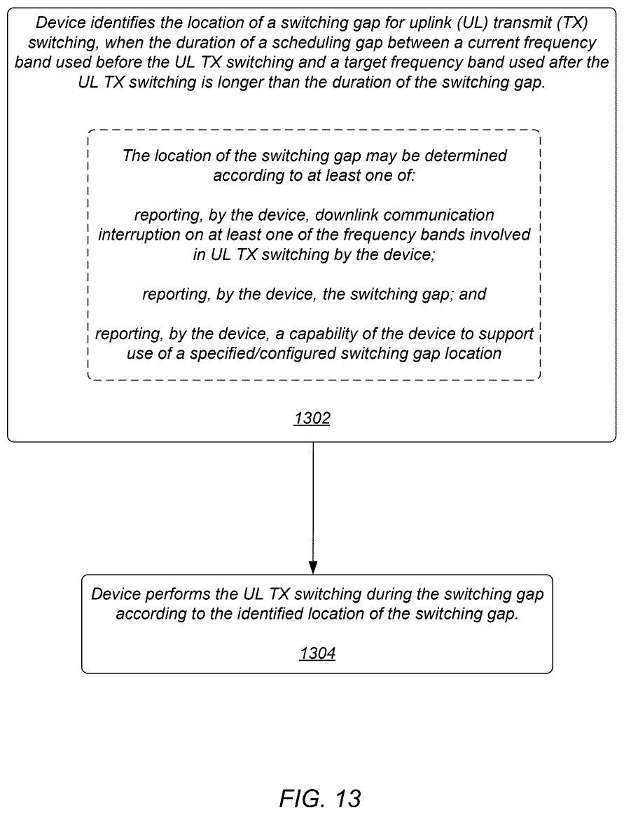

FIG. 13 shows an exemplary flow diagram of a method for a device, e.g., UE, performing UL TX switching. A device may be instructed to switch from performing UL transmissions on one or more current frequency bands to performing UL transmissions on one or more target frequency bands. At 1302, the device may identify the location of the switching gap for the UL TX switching, when the duration of a scheduling gap between a current frequency band used before the UL TX switching and a target frequency band used after the UL TX switching is longer than the duration of the switching gap. The switching gap may be determined according to at least one of:
reporting, by the device, downlink communication interruption on at least one of frequency bands involved in UL TX switching by the device;
reporting, by the device, the switching gap; and
reporting, by the device, a capability of the device to support use of a specified/configured switching gap location.

At 1304, the device may perform the UL TX switching during the switching gap/period according to the identified location of the switching gap/period.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Embodiments of the present invention may be realized in any of various forms. For example, in some embodiments, the present invention may be realized as a computer-implemented method, a computer-readable memory medium, or a computer system. In other embodiments, the present invention may be realized using one or more custom-designed hardware devices such as ASICs. In other embodiments, the present invention may be realized using one or more programmable hardware elements such as FPGAs.

In some embodiments, a non-transitory computer-readable memory medium (e.g., a non-transitory memory element) may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

In some embodiments, a device (e.g., a UE) may be configured to include a processor (or a set of processors) and a memory medium (or memory element), where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

1. A method for switching uplink (UL) transmission of a device from at least a first frequency band (FB) to at least a second FB, the method comprising:
identifying, by the device, a location of a switching gap, when a duration of a scheduling gap between the first FB and the second FB is longer than a duration of the switching gap; and
performing, by the device, the switching during the switching gap according to the identified location of the switching gap.

2. The method of claim 1, further comprising:
identifying the location of the switching gap according to at least one of:
reporting of downlink communication interruption on at least one of the first FB and the second FB,
reporting of the switching gap, and
reporting of a capability of the device to support use of a configured switching gap location.

3. The method of claim 1, wherein the identified location of the switching gap ends at an end of the scheduling gap.

4. The method of claim 3, wherein the identified location of the switching gap ends at the end of the scheduling gap in response to at least one of:
a switching gap location parameter received by the device identifying the second FB; and
the first FB having a higher priority than the second FB.

5. The method of claim 1, wherein the identified location of the switching gap starts at a beginning of the scheduling gap.

6. The method of claim 5, wherein the identified location of the switching gap starts at the beginning of the scheduling gap in response to at least one of:
a switching gap location parameter received by the device identifying the first FB; and
the second FB having a higher priority than the first FB.

7. The method of claim 1, wherein the identified location of the switching gap starts at a midpoint of the scheduling gap.

8. The method of claim 1, wherein the identified location of the switching gap ends at a midpoint of the scheduling gap.

9. The method of claim 1, wherein the identified location of the switching gap is the configured switching gap location when the device reports, to a base station:
a downlink communication interruption on at least one of the first FB and the second FB; and
the switching gap.

10. The method of claim 1, wherein the identified location of the switching gap is the configured switching gap location when the device reports, to a base station, a downlink communication interruption on all bands within a band combination of a switching instance.

11. The method of claim 1, wherein the identified location of the switching gap is the configured switching gap location when the device reports, to a base station, a downlink communication interruption on all bands involved in a given switching instance.

12. The method of claim 1, wherein the identified location of the switching gap is the configured switching gap location when the device reports, to a base station, a downlink communication interruption on at least one band that is involved in a given switching instance.

13. An apparatus comprising:
a processor configured to:
instruct a device to identify a location of a switching gap for switching uplink (UL) transmission of the device from at least a first frequency band (FB) to at least a second FB, when a duration of a scheduling gap between the first FB and the second FB is longer than a duration of the switching gap; and
instruct the device to perform the switching during the switching gap according to the identified location of the switching gap.

14. The apparatus of claim 13, wherein the location of the switching gap is identified according to at least one of:
reporting of downlink communication interruption on at least one of the first FB and the second FB;
reporting of the switching gap; and
reporting of a capability of the device to support use of a configured switching gap location.

15. The apparatus of claim 13 wherein the identified location of the switching gap ends at an end of the scheduling gap,
wherein the identified location of the switching gap ends at the end of the scheduling gap in response to at least one of:
a switching gap location parameter received by the device identifying the second FB; and
the first FB having a higher priority than the second FB.

16. (canceled)

17. The apparatus of claim 13, wherein the identified location of the switching gap starts at a beginning of the scheduling gap,
wherein the identified location of the switching gap starts at the beginning of the scheduling gap in response to at least one of:
a switching gap location parameter received by the device identifying the first FB; and
the second FB having a higher priority than the first FB.

18. (canceled)

19. The apparatus of claim 13, wherein the identified location of the switching gap either starts at a midpoint of the scheduling gap or ends at the midpoint of the scheduling gap.

20. The apparatus of claim 13, wherein the identified location of the switching gap is the configured switching gap location when the device reports, to a base station:
a downlink communication interruption on at least one of the first FB and the second FB; and
the switching gap.

21. (canceled)

22. A device comprising;
radio frequency circuitry configured to enable wireless communications of a device; and
a processor communicatively coupled to the radio frequency circuit and configured to cooperate with the radio frequency circuitry to:
identify a location of a switching gap for switching uplink (UL) transmission of the device from at least a first frequency band (FB) to at least a second FB, when a duration of a scheduling gap between the first FB and the second FB is longer than a duration of the switching gap; and
perform the switching during the switching gap according to the identified location of the switching gap.

23. The device of claim 22, wherein the location of the switching gap is identified according to at least one of:
reporting of downlink communication interruption on at least one of the first FB and the second FB;
reporting of the switching gap; and
reporting of a capability of the device to support use of a configured switching gap location.

24-30. (canceled)
